(19) United States
(12) Patent Application Publication
(10) Pub. No.: US 2022/0140404 A1
(43) Pub. Date: May 5, 2022

(54) MANUFACTURING METHOD OF SOLID STATE BATTERY AND SOLID STATE BATTERY

(71) Applicant: Murata Manufacturing Co., Ltd., Nagaokakyo-shi (JP)

(72) Inventors: Kenji OSHIMA, Nagaokakyo-shi (JP); Makoto YOSHIOKA, Nagaokakyo-shi (JP)

(73) Assignees: Murata Manufacturing Co., Ltd., Nagaokakyo-shi, Kyoto-fu (JP); Murata Manufacturing Co., Ltd., Nagaokakyo-shi, Kyoto-fu (JP)

(21) Appl. No.: 17/574,810

(22) Filed: Jan. 13, 2022

Related U.S. Application Data
(63) Continuation of application No. PCT/JP2020/033459, filed on Sep. 3, 2020.

(30) Foreign Application Priority Data
Sep. 4, 2019 (JP) 2019-161456

(51) Int. Cl. H01M 10/0585; H01M 10/0525; H01M 4/62; H01M 50/547

(52) U.S. Cl. CPC H01M 10/0585; H01M 50/547; H01M 4/628; H01M 10/0525

(57) ABSTRACT

A method of manufacturing a solid state battery that includes forming a solid state battery precursor by sequentially laminating a positive electrode layer sheet, a solid electrolyte layer sheet, and a negative electrode layer sheet along a laminating direction; providing a terminal non-connection portion contact sheet so as to contact a terminal non-connection portion of an outer edge portion of each of the positive electrode layer sheet and the negative electrode layer sheet, wherein the terminal non-connection portion contact sheet has a ratio of a thermal expansion coefficient of at least one of a solid electrolyte material and an insulating material contained in the terminal non-connection portion contact sheet to a thermal expansion coefficient of an electrode material contained in at least one of the positive electrode layer sheet and the negative electrode layer sheet of 0.7 or more and less than 1.5; and firing the solid state battery precursor.

### CROSS REFERENCE TO RELATED APPLICATIONS

The present application is a continuation of International application No. PCT/JP2020/033459, filed Sep. 3, 2020, which claims priority to Japanese Patent Application No. 2019-161456, filed Sep. 4, 2019, the entire contents of each of which are incorporated herein by reference.

### FIELD OF THE INVENTION

The present invention relates to a manufacturing method of a solid state battery and a solid state battery.

### BACKGROUND OF THE INVENTION

Conventionally, secondary batteries that can be repeatedly charged and discharged have been used for various applications. For example, the secondary battery is used as a power source of an electronic device such as a smartphone or a notebook computer.

In the secondary battery, a liquid electrolyte (electrolytic solution) such as an organic solvent has been conventionally used as a medium for moving ions. However, the secondary battery including the electrolytic solution has a problem such as the leakage of the electrolytic solution. Therefore, a solid state battery having a solid electrolyte instead of the liquid electrolyte has been developed.

Patent Document 1: Japanese Patent Application Laid-Open No. 2007-5279

### SUMMARY OF THE INVENTION

Generally, a manufacturing method of the solid state battery includes a forming process of a solid state battery precursor, and a firing process of the formed solid state battery precursor. The forming process of the solid state battery precursor 500α′ includes sequentially laminating a positive electrode layer sheet 10Aα′, a solid electrolyte layer sheet 20α′, and a negative electrode layer sheet 10Bα′ along a laminating direction, and providing at least one of a solid electrolyte portion sheet and an insulating portion sheet in contact with a terminal non-connection portion of an outer edge portion of each of the positive electrode layer sheet 10Aα′ and the negative electrode layer sheet 10Bα′ so as to surround the terminal non-connection portion (see FIG. 3).

The inventors of the present application have newly found that the following problems may occur at the time of performing the firing process of the solid state battery precursor 500α′.

Specifically, thermal expansion coefficients of the components of the solid state battery precursor 500α′ may differ due to differences in material properties. In particular, since 30α′ of at least one of the solid electrolyte portion sheet and the insulating portion sheet is provided so as to be in contact with an outer edge portion of an electrode layer sheet 10α′ (positive electrode layer sheet 10Aα′/negative electrode layer sheet 10Bα′), stress may be generated in a contact region between a terminal non-connection portion 13α′ of an outer edge portion 11α′ of the electrode layer sheet 10α′ and the terminal non-connection portion contact sheet 30α′ due to the difference between a thermal expansion coefficient of at least one of a solid electrolyte material and an insulating material contained in the terminal non-connection portion contact sheet 30α′ and a thermal expansion coefficient of an electrode material contained in the electrode layer sheet 10α′. Therefore, due to the stress, a crack 40α′ may occur in the contact region between the electrode layer sheet 10α′ and the terminal non-connection portion contact sheet 30α′ during the firing process of the solid state battery precursor 500α′. As a result, there is a possibility that the charging and discharging of the solid state battery finally obtained cannot be suitably performed.

The present invention has been made in view of such circumstances. That is, a main object of the present invention is to provide a manufacturing method of a solid state battery capable of suitably suppressing the occurrence of a crack during manufacturing, and a solid state battery obtained from the manufacturing method.

In order to achieve the above object, an embodiment of the present invention provides a method of manufacturing a solid state battery that includes forming a solid state battery precursor by sequentially laminating a positive electrode layer sheet, a solid electrolyte layer sheet, and a negative electrode layer sheet along a laminating direction; providing a terminal non-connection portion contact sheet so as to contact a terminal non-connection portion of an outer edge portion of each of the positive electrode layer sheet and the negative electrode layer sheet, wherein the terminal non-connection portion contact sheet has a ratio of a thermal expansion coefficient of at least one of a solid electrolyte material and an insulating material contained in the terminal non-connection portion contact sheet to a thermal expansion coefficient of an electrode material contained in at least one of the positive electrode layer sheet and the negative electrode layer sheet of 0.7 or more and less than 1.5; and firing the solid state battery precursor.

In order to achieve the above object, an embodiment of the present invention provides a solid state battery that includes at least one battery configuration unit including: a positive electrode layer having a positive electrode material layer and a positive electrode layer active material low-containing portion contacting a terminal non-connection outer edge portion of the positive electrode material layer; a negative electrode layer having a negative electrode material layer and a negative electrode layer active material low-containing portion contacting a terminal non-connection outer edge portion of the negative electrode material layer; and a solid electrolyte layer interposed between the positive electrode layer and the negative electrode layer along a laminating direction, in which a ratio of a thermal expansion coefficient of at least one of (1) the positive electrode layer active material low-containing portion to a thermal expansion coefficient of the positive electrode material layer, and (2) the negative electrode layer active material low-containing portion to a thermal expansion coefficient of the negative electrode material layer, is 0.7 or more and less than 1.5.

According to an embodiment of the present invention, it is possible to suitably suppress the occurrence of a crack during manufacturing.

### BRIEF EXPLANATION OF THE DRAWINGS

FIG. 1 is a schematic diagram of a manufacturing method of a solid state battery according to an embodiment of the present invention.

FIG. 2 is an exploded perspective view schematically illustrating the solid state battery according to an embodiment of the present invention.

FIG. 3 is a schematic diagram of a conventional manufacturing method of a solid state battery.

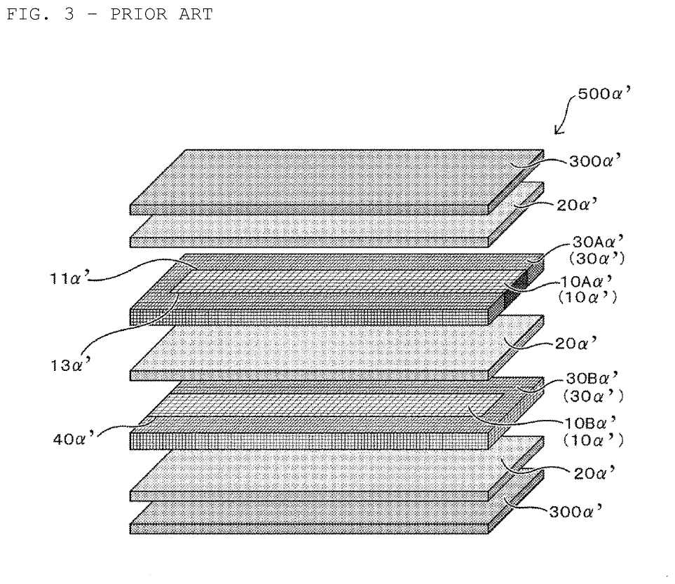

### DETAILED DESCRIPTION OF THE INVENTION

Before describing a solid state battery according to an embodiment of the present invention, a basic configuration of the solid state battery will be described. The term “solid state battery” as used herein refers in a broad sense to a battery whose component is configured of a solid, and in a narrow sense to an all solid state battery whose components (particularly, all components) are configured of solids. In a preferred aspect, the solid state battery of the present invention is a laminating type solid state battery configured such that respective layers configuring a battery configuration unit are laminated with each other, and preferably, such respective layers are configured of a sintering body. The term “solid state battery” as used herein can include, not only a secondary battery capable of repeating charging and discharging, but also a primary battery capable of only discharging. In a preferred aspect of the present invention, the solid state battery is the secondary battery. The term “secondary battery” is not excessively limited by its name, and can also include, for example, a power storage device and the like.

The term “sectional view” as used herein refers to a state when the solid state battery is viewed from a direction substantially perpendicular to a thickness direction on the basis of a laminating direction of electrode material layers configuring the solid state battery. The term “plan view” as used herein refers to a state in which the solid state battery is viewed from above or below along the thickness direction on the basis of the laminating direction of the electrode material layers configuring the solid state battery. The term “up-down direction” and the term “left-right direction” used directly or indirectly in the present specification correspond to the up-down direction and the left-right direction in the drawings, respectively. Unless otherwise specified, the same reference numerals or symbols indicate the same members/portions or the same semantic contents. In a preferred aspect, it can be understood that a downward direction in a vertical direction (that is, a direction in which gravity acts) corresponds to a “down direction”, and the opposite direction corresponds to an “up direction”.

[A Basic Configuration of the Solid State Battery]

The solid state battery adopts a configuration in which at least one battery configuration unit including a positive electrode layer and a negative electrode layer facing each other and a solid electrolyte layer interposed between the positive electrode layer and the negative electrode layer is provided along the laminating direction. In detail, the solid state battery adopts a configuration in which the positive electrode layer, the solid electrolyte layer, and the negative electrode layer are integrally sintered.

The positive electrode layer has at least a positive electrode material layer, and further has a positive electrode current collector layer additionally. In this case, the positive electrode material layer is provided on at least one face of the positive electrode current collector layer. The positive electrode material layer is configured of a sintering body containing positive electrode active material particles and solid electrolyte particles. The negative electrode layer has at least a negative electrode material layer, and further has a negative electrode current collector layer additionally. In this case, the negative electrode material layer is provided on at least one face of the negative electrode current collector layer. The negative electrode material layer is configured of a sintering body containing negative electrode active material particles and solid electrolyte particles.

The positive electrode layer and/or the negative electrode layer may contain a conductivity aid. As the conductivity aid contained in the positive electrode layer and the negative electrode layer, at least one of metal materials such as silver, palladium, gold, platinum, aluminum, copper, and nickel, carbon, and the like can be given. Although not particularly limited, the carbon is preferable in that the carbon hardly reacts with a positive electrode active material, a negative electrode active material, a solid electrolyte material, and the like, and exhibits an effect of reducing an internal resistance of the solid state battery.

Further, the positive electrode layer and/or the negative electrode layer may contain a sintering aid. As the sintering aid, at least one selected from the group consisting of a lithium oxide, a sodium oxide, a potassium oxide, a boron oxide, and a silicon oxide can be given.

The positive electrode active material contained in the positive electrode material layer and the negative electrode active material contained in the negative electrode material layer are substances involved in the transfer of electrons in the solid state battery, and ions contained in the active material move (conduct) between a positive electrode and a negative electrode to transfer the electrons, whereby charging and discharging are performed. The positive electrode material layer and the negative electrode material layer are particularly preferably layers capable of occluding and releasing lithium ions. That is, the solid state battery is preferably a solid state secondary battery in which the lithium ions move between the positive electrode and the negative electrode via the solid electrolyte layer to charge and discharge the battery.

(Positive Electrode Current Collector/Negative Electrode Current Collector)

A positive electrode current collector and a negative electrode current collector may each have a foil form, but may each have a sintering body form from the viewpoint of reducing the manufacturing cost of the solid state battery by integral firing, reducing the internal resistance of the solid state battery, and the like. Note that when the positive electrode current collector and the negative electrode current collector each have the sintering body form, the positive electrode current collector and the negative electrode current collector may be each configured of the sintering body containing the conductivity aid and the sintering aid. The conductivity aid contained in each of the positive electrode current collector and the negative electrode current collector is selected from, for example, the same material as the conductivity aid that can be contained in each of the positive electrode layer and the negative electrode layer. The sintering aid contained in each of the positive electrode current collector and the negative electrode current collector is selected from, for example, the same material as the sintering aid that can be contained in each of the positive electrode layer and the negative electrode layer.

(Positive Electrode Active Material)

As the positive electrode active material contained in the positive electrode material layer, for example, at least one selected from the group consisting of a lithium-containing phosphate compound having a NASICON-type structure, a lithium-containing phosphate compound having an olivine-type structure, a lithium-containing layered oxide, a lithium-containing oxide having a spinel-type structure, and the like can be given. Examples of the lithium-containing phosphate compound having a NASICON-type structure include Li₃V₂(PO₄)₃ and the like. Examples of the lithium-containing phosphate compound having an olivine-type structure include LiFePO₄, LiMnPO₄, and the like. Examples of the lithium-containing layered oxide include LiCoO₂, LiCo_{1/3}Ni_{1/3}Mn_{1/3}O₂, and the like. Examples of the lithium-containing oxide having a spinel-type structure include LiMn₂O₄, LiNi_{0.5}Mn_{1.5}O₄, and the like.

(Negative Electrode Active Material)

As the negative electrode active material contained in the negative electrode material layer, for example, at least one selected from the group consisting of an oxide containing at least one element selected from the group consisting of Ti, Si, Sn, Cr, Fe, Nb, and Mo, a graphite-lithium compound, a lithium alloy, a lithium-containing phosphate compound having a NASICON-type structure, a lithium-containing oxide having a spinel-type structure, and the like can be given. Examples of the lithium alloy include Li—Al and the like. Examples of the lithium-containing phosphate compound having a NASICON-type structure include Li₃V₂(PO₄)₃ and the like. Examples of the lithium-containing oxide having a spinel-type structure include Li₄Ti₅O₁₂ and the like.

(Solid Electrolyte Material)

Examples of the material of the solid electrolyte particles (that is, the solid electrolyte material) that can be contained in the solid electrolyte layer, the positive electrode material layer, and/or the negative electrode material layer include, for example, a lithium-containing phosphate compound having a NASICON structure, an oxide having a perovskite structure, an oxide having a garnet-type or garnet-type similar structure, and the like. Examples of the lithium-containing phosphate compound having a NASICON structure include LiₓM_{y}(PO₄)₃ (1≤x≤2, 1≤y≤2, and M is at least one selected from the group consisting of Ti, Ge, Al, Ga, and Zr). Examples of the lithium-containing phosphate compound having a NASICON structure include, for example, Li_{1.2}Al_{0.2}Ti_{1.8}(PO₄)₃ and the like. Examples of the oxide having a perovskite structure include La_{0.55}Li_{0.35}TiO₃ and the like. Examples of the oxide having a garnet-type or garnet-type similar structure include Li₇La₃Zr₂O₁₂ and the like. The solid electrolyte layer may contain the sintering aid. The sintering aid contained in the solid electrolyte layer is selected from, for example, the same material as the sintering aid that can be contained in the positive electrode layer and the negative electrode layer.

(Terminal)

The solid state battery is typically provided with an end face. In particular, the end face is provided on a side face of the solid state battery. More specifically, a positive electrode terminal connected to the positive electrode layer and a negative electrode terminal connected to the negative electrode layer are provided. Such a terminal preferably contains a material having high conductivity. A specific material of the terminal is not particularly limited, but at least one selected from the group consisting of silver, gold, platinum, aluminum, copper, tin, and nickel can be given.

(Protective Layer)

In addition, a protective layer that covers at least a part of an outer face of at least one battery configuration unit is further provided except for the terminal. The protective layer is formed on an outermost side of the solid state battery, and is used for electrical, physical, and chemical protection. A material configuring the protective layer is preferably excellent in insulation properties, durability, and moisture resistance, and is environmentally safe. For example, glass, ceramics, a thermosetting resin, a photocurable resin, or the like is preferably used.

[A Manufacturing Method of a Solid State Battery of the Present Invention]

A manufacturing method of a solid state battery according to an embodiment of the present invention will be described below on the basis of the basic configuration of the solid state battery.

The inventors of the present application have intensively studied a solution capable of suitably suppressing the occurrence of a crack during the manufacturing of the solid state battery. As a result, the inventors of the present application have devised the manufacturing method according to an embodiment of the present invention on the basis of a technical idea that a terminal non-connection portion contact sheet having an adjusted thermal expansion coefficient is used at the time of manufacturing the solid state battery.

Specifically, the inventors of the present application have devised the manufacturing method according to an embodiment of the present invention on the basis of a technical idea that limiting a ratio of a thermal expansion coefficient of at least one of a solid electrolyte material and an insulating material contained in a terminal non-connection portion contact sheet to a thermal expansion coefficient of an electrode material contained in an electrode layer sheet to within a predetermined range at the time of manufacturing the solid state battery.

The term “terminal non-connection portion contact sheet” as used herein refers to a sheet containing at least one of an insulating portion sheet containing the insulating material and a solid electrolyte portion sheet containing the solid electrolyte material. The term “electrode material” as used herein refers in a broad sense to a material configuring an electrode layer that is the component of the solid state battery finally obtained, and in a narrow sense to a material configuring an electrode material layer containing an electrode active material that is the component of the electrode layer. The term “active material low-containing portion” as used herein refers to at least one of an insulating portion and a solid electrolyte portion in which a content of an active material is 0 vol % or more and less than 30 vol %. The term “insulating portion” as used herein refers to a portion containing the insulating material. The term “solid electrolyte portion” as used herein refers to a portion containing the solid electrolyte material.

As will be described herein, at the time of manufacturing the solid state battery, the terminal non-connection portion contact sheet is provided so as to be in contact with a terminal non-connection portion of an outer edge portion of the electrode layer sheet. The thermal expansion coefficient of at least one of the solid electrolyte material and the insulating material contained in the terminal non-connection portion contact sheet may be different from the thermal expansion coefficient of the electrode material contained in the electrode layer sheet. Therefore, due to this, in the firing process of the solid state battery precursor (also referred to as an unfired laminating body), stress may be generated in a contact region between the terminal non-connection portion of the outer edge portion of the electrode layer sheet and the terminal non-connection portion contact sheet.

In this regard, according to the technical idea described above, the ratio of the thermal expansion coefficient of at least one of the solid electrolyte material and the insulating material contained in the terminal non-connection portion contact sheet to the thermal expansion coefficient of the electrode material contained in the electrode layer sheet is limited to within a predetermined range of 0.7 or more and less than 1.5. Thus, the difference between the thermal expansion coefficient of the electrode layer sheet and the thermal expansion coefficient of the terminal non-connection portion contact sheet can be limited. As a result, it is possible to alleviate the stress generated in the contact region between the terminal non-connection portion of the outer edge portion of the electrode layer sheet and the terminal non-connection portion contact sheet during the firing process of the solid state battery precursor, and it is possible to suppress the occurrence of a crack at the completion of the firing process. Therefore, it is possible to finally obtain the solid state battery in which the occurrence of a crack is suppressed.

Hereinafter, the manufacturing method of the solid state battery according to an embodiment of the present invention will be specifically described. Note that the present manufacturing method is merely an example, and it will be described in advance that the case of using another method (screen printing method or the like) is not excluded.

The solid state battery according to an embodiment of the present invention can be manufactured by using a green sheet method. In an aspect, after a predetermined laminating body is formed by the green sheet method, the solid state battery according to an embodiment of the present invention can be finally manufactured. Note that in the following description, the description will be made on the premise of the aspect, but the present invention is not limited thereto, and the predetermined laminating body may be formed by the screen printing method or the like.

(Forming Process of the Solid State Battery Precursor (Unfired Laminating Body))

First, a solid electrolyte layer paste, a positive electrode material layer paste, a positive electrode current collector layer paste, a negative electrode material layer paste, a negative electrode current collector layer paste, and a protective layer paste are applied onto each substrate (for example, a PET film).

Each paste can be prepared by wet-mixing the predetermined configuring material of each layer appropriately selected from the group consisting of the positive electrode active material, the negative electrode active material, the conductive material, the solid electrolyte material, the insulating material, and the sintering aid with an organic vehicle in which an organic material is dissolved in a solvent. The positive electrode material layer paste contains, for example, the positive electrode active material, the conductive material, the solid electrolyte material, the organic material, and the solvent. The negative electrode material layer paste contains, for example, the negative electrode active material, the conductive material, the solid electrolyte material, the organic material, and the solvent. As the positive electrode current collector layer paste/negative electrode current collector layer paste, for example, at least one from the group consisting of silver, palladium, gold, platinum, aluminum, copper, and nickel is selected. The solid electrolyte layer paste and a solid electrolyte portion paste described later contain, for example, the solid electrolyte material, the sintering aid, the organic material, and the solvent. The protective layer paste contains, for example, the insulating substance material, the organic material, and the solvent. An insulating portion paste contains, for example, the insulating material, the organic material, and the solvent. The solid electrolyte portion paste contains, for example, the solid electrolyte material, the sintering aid, the organic material, and the solvent.

In the wet-mixing, a medium can be used, and specifically, a ball mill method, a viscomill method, or the like can be used. On the other hand, the wet-mixing method without using the medium may be used, and a sand mill method, a high pressure homogenizer method, a kneader dispersion method, or the like can be used.

The predetermined solid electrolyte layer paste and the predetermined solid electrolyte portion paste can be prepared by wet-mixing the predetermined solid electrolyte material, sintering aid, and organic vehicle in which the organic material is dissolved in the solvent. Examples of the material of the solid electrolyte particles (that is, the solid electrolyte material) include, for example, a lithium-containing phosphate compound having a NASICON structure, an oxide having a perovskite structure, an oxide having a garnet-type or garnet-type similar structure, and the like.

As a positive electrode active material contained in the positive electrode material layer paste, for example, at least one from the group consisting of a lithium-containing phosphate compound having a NASICON-type structure, a lithium-containing phosphate compound having an olivine-type structure, a lithium-containing layered oxide, a lithium-containing oxide having a spinel-type structure, and the like is selected.

The insulating material contained in the insulating portion paste described later can be made of, for example, a glass material, a ceramic material, or the like. As the insulating substance material contained in the protective layer paste, it is preferable to use, for example, at least one selected from the group consisting of a glass material, a ceramic material, a thermosetting resin material, a photocurable resin material, and the like.

The organic material contained in the paste is not particularly limited, but at least one high polymer material selected from the group consisting of a polyvinyl acetal resin, a cellulose resin, a polyacrylic resin, a polyurethane resin, a polyvinyl acetate resin, a polyvinyl alcohol resin, and the like can be used. The solvent is not particularly limited as long as the organic material can be dissolved, and for example, toluene and/or ethanol or the like can be used.

As a negative electrode active material contained in the negative electrode material layer paste, for example, at least one from the group consisting of an oxide containing at least one element selected from the group consisting of Ti, Si, Sn, Cr, Fe, Nb, and Mo, a graphite-lithium compound, a lithium alloy, a lithium-containing phosphate compound having a NASICON-type structure, a lithium-containing phosphate compound having an olivine-type structure, a lithium-containing oxide having a spinel-type structure, and the like is selected.

The sintering aid can be at least one selected from the group consisting of a lithium oxide, a sodium oxide, a potassium oxide, a boron oxide, and a silicon oxide.

The applied pastes are dried on a hot plate heated to 30 to 50° C. to form, on the substrate (for example, the PET film), each of a solid electrolyte layer sheet having a predetermined thickness, a positive electrode layer sheet containing the positive electrode material layer, and a negative electrode layer sheet containing the negative electrode material layer. Note that in the present specification, since a current collector is not an essential component, a sheet containing at least the electrode material layer is represented as the electrode layer sheet.

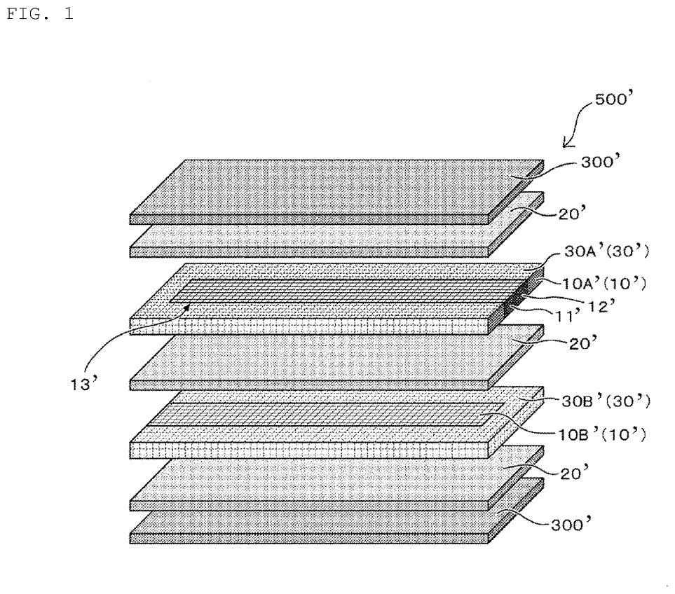

Next, each sheet is peeled off from the substrate. After the peeling, the sheets of the respective components of the battery configuration unit are sequentially laminated along the laminating direction (see FIG. 1). Specifically, a positive electrode layer sheet 10A′, a solid electrolyte layer sheet 20′, and a negative electrode layer sheet 10B′ are sequentially laminated along the laminating direction.

In the laminating stage, a terminal non-connection portion contact sheet 30′ such as the solid electrolyte portion sheet, the insulating portion sheet, or the like is provided by the screen printing in a side region of an electrode layer sheet 10′ so as to be partly in contact with an outer edge portion 11′ of the electrode layer sheet 10′ in plan view. Specifically, the terminal non-connection portion contact sheet 30′ is provided so as to be in contact with a terminal non-connection portion 13′ excluding a portion 12′ to which the terminal is connected later in the outer edge portion 11′ of the electrode layer sheet 10′. In addition, the terminal non-connection portion contact sheet is provided so as to surround the terminal non-connection portion 13′ of the outer edge portion 11′ of the electrode layer sheet 10′ in plan view. That is, the terminal non-connection portion contact sheet is provided so as to be in contact with the terminal non-connection portion 13′ of the outer edge portion 11′ of the electrode layer sheet 10′ and surround the terminal non-connection portion 13′.

More specifically, the terminal non-connection portion contact sheet 30′ having an adjusted thermal expansion coefficient is provided so as to be in contact with the terminal non-connection portion 13′ of the outer edge portion 11′ of the electrode layer sheet 10′. In particular, in an embodiment of the present invention, the terminal non-connection portion contact sheet 30′ in which a ratio of a thermal expansion coefficient of at least one of the solid electrolyte material and the insulating material contained in the terminal non-connection portion contact sheet 30′ to a thermal expansion coefficient of the electrode material contained in the electrode layer sheet 10′ is limited to within a predetermined range of 0.7 or more and less than 1.5 is provided.

Note that, by using the insulating portion sheet as the terminal non-connection portion contact sheet 30′ as an example, the thermal expansion coefficient can be controlled to the desired value or range by introducing various ceramic materials into a glass material that is the configuring material of the insulating portion paste.

In addition, at the stage of manufacturing the electrode layer sheet, as the configuring material of the electrode material layer paste, the insulating material is further introduced in addition to the active material, the conductive material, the solid electrolyte material, the organic material, and the solvent. Alternatively, material ratios of the respective active material, conductive material, solid electrolyte material, organic material, and solvent as the configuring materials of the electrode material layer paste may be adjusted. As described above, the thermal expansion coefficient of the electrode material contained in the electrode layer sheet can be similarly controlled to the desired value or range. Note that from the viewpoint of avoiding reduction in the energy density of the solid state battery finally obtained, it is more preferable to perform adjustment so as not to lower the content ratio of the active material contained in the electrode material layer paste.

It is then preferable to perform thermocompression bonding at a predetermined pressure (e.g., from about 50 to about 100 MPa) followed by isostatic pressing at a predetermined pressure (e.g., from about 150 to about 300 MPa). As described above, a predetermined solid state battery precursor 500′ (unfired laminating body) can be formed.

(Firing Process)

The obtained predetermined solid state battery precursor 500′ (unfired laminating body) is subjected to firing. The firing is performed by heating at, for example, 600° C. to 1000° C. in a nitrogen gas atmosphere.

As described herein, the thermal expansion coefficient of at least one of the solid electrolyte material and the insulating material contained in the terminal non-connection portion contact sheet 30′ may be different from the thermal expansion coefficient of the electrode material contained in the electrode layer sheet 10′. Therefore, due to this, in the firing process of the solid state battery precursor 500′ (also referred to as the unfired laminating body), stress may be generated in a contact region between the terminal non-connection portion 13′ of the outer edge portion 11′ of the electrode layer sheet 10′ and the terminal non-connection portion contact sheet 30′.

In this regard, in an embodiment of the present invention, the ratio of the thermal expansion coefficient of at least one of the solid electrolyte material and the insulating material contained in the terminal non-connection portion contact sheet 30′ to the thermal expansion coefficient of the electrode material contained in the electrode layer sheet 10′ is limited to be within the predetermined range of 0.7 or more and less than 1.5. Thus, the difference between the thermal expansion coefficient of the electrode layer sheet 10′ and the thermal expansion coefficient of the terminal non-connection portion contact sheet 30′ can be limited. As a result, it is possible to alleviate the stress generated in the contact region between the terminal non-connection portion 13′ of the outer edge portion 11′ of the electrode layer sheet and the terminal non-connection portion contact sheet.

Next, the terminal is attached to the obtained laminating body. The terminal is provided so as to be electrically connectable to each of the positive electrode layer and the negative electrode layer. For example, it is preferable to form the terminal by sputtering or the like. Although not particularly limited, the terminal is preferably configured of at least one material selected from silver, gold, platinum, aluminum, copper, tin, and nickel. Furthermore, it is preferable to provide a protective layer 300′ to such an extent that the terminal is not covered by sputtering, spray coating, or the like.

As described above, the solid state battery according to an embodiment of the present invention can be suitably manufactured.

As described above, in the manufacturing method according to an embodiment of the present invention, the terminal non-connection portion contact sheet 30′ in which the ratio of the thermal expansion coefficient of at least one of the solid electrolyte material and the insulating material contained in the terminal non-connection portion contact sheet 30′ to the thermal expansion coefficient of the electrode material contained in the electrode layer sheet 10′ is limited to within a predetermined range of 0.7 or more and less than 1.5 is provided in the firing process. As a result, it is possible to alleviate the stress generated in the contact region between the terminal non-connection portion 13′ of the outer edge portion 11′ of the electrode layer sheet and the terminal non-connection portion contact sheet during the firing process. As a result, it is possible to suppress the occurrence of a crack when the firing process is completed. Therefore, the solid state battery in which the occurrence of a crack is suppressed can be finally obtained, and charging and discharging can be suitably performed by using such the solid state battery.

[A Solid State Battery of the Present Invention]

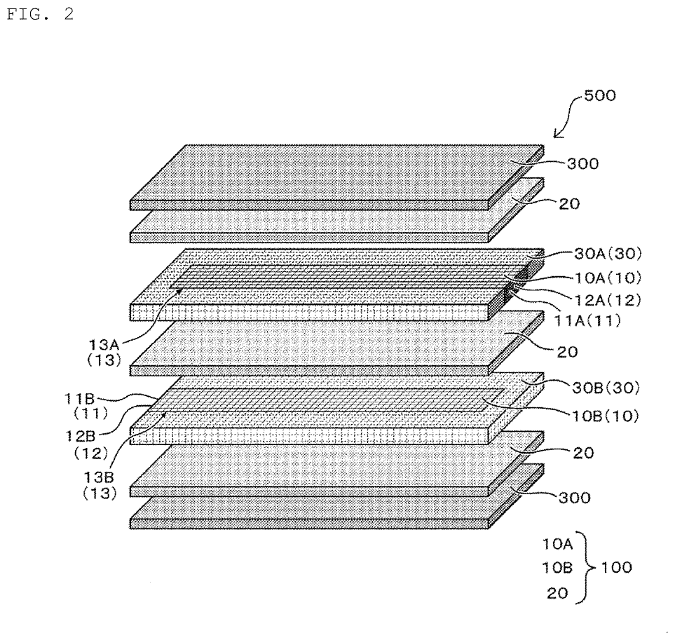

A solid state battery 500 according to an embodiment of the present invention obtained according to the above manufacturing method has the following technical features (see FIG. 2).

As illustrated in FIG. 2, the solid state battery 500 according to an embodiment of the present invention includes at least one battery configuration unit 100 including a positive electrode layer 10A, a negative electrode layer 10B, and a solid electrolyte layer 20 interposed between the positive electrode layer 10A and the negative electrode layer 10B along the laminating direction. The positive electrode layer 10A contains the positive electrode material layer, and the negative electrode layer 10B contains the negative electrode material layer.

The positive electrode layer 10A has a main face portion facing the solid electrolyte layer 20, and an outer edge portion 11A extending in a direction substantially perpendicular to an extending direction of the main face portion. The outer edge portion 11A contains a terminal connection portion 12A and a terminal non-connection portion 13A surrounded by a positive electrode active material low-containing portion 30A (active material low-containing portion 30).

The negative electrode layer 10B has a main face portion facing the solid electrolyte layer 20, and an outer edge portion 11B extending in a direction substantially perpendicular to an extending direction of the main face portion. The outer edge portion 11B contains an external terminal connection portion 12B and a terminal non-connection portion 13B surrounded by a positive electrode active material low-containing portion 30B (active material low-containing portion 30).

That is, the electrode layer 10 (positive electrode layer 10A/negative electrode layer 10B) has a main face portion facing the solid electrolyte layer 20, and an outer edge portion 11 extending in a direction substantially perpendicular to an extending direction of the main face portion. The outer edge portion 11 contains a terminal connection portion 12 and a terminal non-connection portion 13 surrounded by the active material low-containing portion 30.

Note that the solvent that can be contained in the electrode layer sheet 10′, the solvent that can be contained in the terminal non-connection portion contact sheet 30′, and the like are volatilized through the firing process in the middle of manufacturing. Therefore, the thermal expansion coefficient of the electrode material contained in the electrode layer sheet and the thermal expansion coefficient of at least one of the solid electrolyte material and the insulating material contained in the terminal non-connection portion contact sheet in the middle of manufacturing correspond to a thermal expansion coefficient of the electrode layer (specifically, the electrode material layer) and a thermal expansion coefficient of the active material low-containing portion after the completion of manufacturing, respectively. Therefore, in the finally obtained solid state battery 500, the ratio of the thermal expansion coefficient of the active material low-containing portion 30 to the thermal expansion coefficient of an electrode layer 10 (specifically, the electrode material layer contained in the electrode layer) is limited to be within the predetermined range of 0.7 or more and less than 1.5. Thus, it is possible to limit the difference between the thermal expansion of the electrode layer 10 (corresponding to the electrode layer sheet 10′ at the completion of firing) and the thermal expansion coefficient of the active material low-containing portion 30 (corresponding to the terminal non-connection portion contact sheet 30′ at the completion of firing) at the time of using the battery. Therefore, as described in the section of the manufacturing method, not only charging and discharging can be suitably started by using the solid state battery 500 obtained by suppressing the occurrence of a crack in the middle of manufacturing, but also such charging and discharging can be suitably continued.

### EXAMPLES

### Comparative Examples

First, Comparative Examples 1 to 9 will be described.

(Forming Process of the Solid State Battery Precursor (Unfired Laminating Body))

First, each of the positive electrode layer sheet, the solid electrolyte layer sheet, and the negative electrode layer sheet, which were the components of the battery configuration unit, was prepared. In Comparative Examples, electrode layers 1 to 3 were used as the positive electrode layer sheet and/or the negative electrode layer sheet (see Table 1). Note that LAGP in Table 1 represents Li_{1.5}Al_{0.5}Ge_{1.5}(PO₄)₃. After the preparation of the respective sheets, the positive electrode layer sheet, the solid electrolyte layer sheet, and the negative electrode layer sheet, which were the respective components of the battery configuration unit, were sequentially laminated along the laminating direction.

At this laminating stage, the terminal non-connection portion contact sheet (specifically, the insulating portion sheet) was provided in a side region of the electrode layer sheet by the screen printing. Specifically, the insulating portion sheet was provided so as to be in contact with the terminal non-connection portion excluding the portion to which the terminal was connected in the outer edge portion of the electrode layer sheet. In Comparative Examples, insulating portion sheets 1 and 4 to 8 were used as the insulating portion sheets.

Next, thermocompression bonding at a predetermined pressure (75 MPa) and subsequent isostatic pressing at a predetermined pressure (200 MPa) were performed. As described above, the solid state battery precursor (unfired laminating body) was formed.

(Firing Process)

Next, the obtained solid state battery precursor (unfired laminating body) was subjected to firing. The firing was performed by heating at 750° C. in a nitrogen gas atmosphere. After firing, the terminal and the protective layer were provided on the obtained laminating body to such an extent that the terminal was not covered.

As described above, the solid state batteries in Comparative Examples were manufactured. Next, 10 battery base bodies obtained in each Comparative Example were prepared, each battery base body was embedded in a resin, and a polished section was observed. Finally, a non-defective rate was determined from the number of non-defectives among the 10 samples.

As a result, as illustrated in Table 1, in Comparative Example 8 in which the ratio of the thermal expansion coefficient of the insulating portion containing the insulating material as a main component to the thermal expansion coefficient of the electrode layer containing the electrode material (corresponding to the member configured of the active material, the conductive material, and the solid electrolyte material) as a main component was less than 0.7 (specifically, 0.6), which was the component of the solid state battery, it was found that the non-defective rate was 30%. In addition, in Comparative Examples 1 to 7 and 9 in which the ratio of the thermal expansion coefficient of the insulating portion containing the insulating material as a main component to the thermal expansion coefficient of the electrode layer containing the electrode material as a main component exceeded 1.5 (specifically, 1.6 or more), which were the components of the solid state batteries, it was found that the non-defective rate was 30% or less.

TABLE 1

| | | | Thermal | | | | Thermal | | | |
|---|---|---|---|---|---|---|---|---|---|---|
| Comp- | | | expansion | | | | expansion | Ratio of | | |
| arative | | | coefficients | | | | coefficient | thermal | Non- | Presence |
| Example | Electrode | Main | (×10−6/ | Insulating | Main | Product | (×10-6/ | expansion | defective | or absence |
| No. | layer | ingredient | ° C.) | layer | ingredient | name | ° C.) | coefficient | rate (%) | of crack |
| 1 | Electrode | LiCoO₂ | 12.9 | Insulating | Bi₂O₃, | ASF-2511C | 8.2 | 1.6 | 30 | Present |
| | layer 1 | (40 wt %), | | portion 4 | ZnO | | | | | |
| | | Carbon | | | | | | | | |
| | | (10 wt %), | | | | | | | | |
| | | LAGP | | | | | | | | |
| | | (50 wt %) | | | | | | | | |
| 2 | Electrode | LiCoO₂ | 12.9 | Insulating | Bi₂O₃, | ASF-1097 | 7.0 | 1.8 | 10 | Present |
| | layer 1 | (40 wt %), | | portion 5 | B₂O₃ | | | | | |
| | | Carbon | | | | | | | | |
| | | (10 wt %), | | | | | | | | |
| | | LAGP | | | | | | | | |
| | | (50 wt %) | | | | | | | | |
| 3 | Electrode | LiCoO₂ | 12.9 | Insulating | Bi₂O₃ , | ASF-1098 | 5.4 | 2.4 | 0 | Present |
| | layer 1 | (40 wt %), | | portion 6 | B₂O₃, | | | | | |
| | | Carbon | | | ZnO | | | | | |
| | | (10 wt %), | | | | | | | | |
| | | LAGP | | | | | | | | |
| | | (50 wt %) | | | | | | | | |
| 4 | Electrode | LiCoO₂ | 12.9 | Insulating | ZnO , | ASF-1099 | 4.7 | 2.7 | 0 | Present |
| | layer1 | (40 wt %), | | portion 7 | Bi₂O₃, | | | | | |
| | | Carbon | | | B₂O₃ | | | | | |
| | | (10 wt %), | | | | | | | | |
| | | LAGP | | | | | | | | |
| | | (50 wt %) | | | | | | | | |
| 5 | Electrode | LiCoO₂ | 12.9 | Insulating | Al₂0₃, | ASF-1898+ | 7.3 | 1.8 | 20 | Present |
| | layer 1 | (40 wt %), | | portion 8 | BaO, | 30 wt % | | | | |
| | | Carbon | | | B₂O₃, | Al₂0₃ | | | | |
| | | (10 wt %), | | | ZnO | | | | | |
| | | LAGP | | | | | | | | |
| | | (50 wt %) | | | | | | | | |
| 6 | Electrode | Li₃V₂ ( PO4) ₃ | 9.6 | Insulating | Bi₂O₃, | ASF-1098 | 5.4 | 1.8 | 10 | Present |
| | layer 2 | (30 wt % ), | | portion 6 | B₂O₃, | | | | | |
| | | TiO₂ | | | ZnO | | | | | |
| | | (10 wt %), | | | | | | | | |
| | | Carbon | | | | | | | | |
| | | (10 wt %), | | | | | | | | |
| | | LAGP | | | | | | | | |
| | | (50 wt %) | | | | | | | | |
| | | Li₃V₂ ( PO4) ₃ | | | | | | | | |
| | | (30 wt % ), | | | | | | | | |
| 7 | Electrode | TiO₂ | 7.5 | Insulating | ZnO, | ASF-1099 | 4.7 | 2.0 | 0 | Present |
| | layer 2 | (10 wt %), | | portion 7 | Bi₂O₃, | | | | | |
| | | Carbon | | | B₂O₃ | | | | | |
| | | (10 wt %), | | | | | | | | |
| | | LAGP | | | | | | | | |
| | | (50 wt %) | | | | | | | | |
| | | Li₃V₂ ( PO4) ₃ | | | | | | | | |
| | | (30 wt % ), | | | | | | | | |
| 8 | Electrode | SiO₂ | 7.5 | Insulating | BaO, | ASF-1702 | 11.9 | 0.6 | 30 | Present |
| | layer 3 | (10 wt %), | | portion 1 | SiO₂, | | | | | |
| | | Carbon | | | ZnO | | | | | |
| | | (10 wt %), | | | | | | | | |
| | | LAGP | | | | | | | | |
| | | (50 wt %) | | | | | | | | |
| | | Li₃V₂ ( PO4) ₃ , | 7.5 | Insulating | ZnO, | ASF-1099 | 4.7 | 1.6 | 30 | Present |
| | | (30 wt % ) | | portion 7 | Bi₂O₃, | | | | | |
| 9 | Electrode | SiO₂ | | | B₂O₃ | | | | | |
| | layer 3 | (10 wt %), | | | | | | | | |
| | | Carbon | | | | | | | | |
| | | (10 wt %), | | | | | | | | |
| | | (50 wt %) | | | | | | | | |
| | | LAGP | | | | | | | | |

### Examples

Next, Examples 1 to 15 will be described. Note that it should be confirmed that a process for obtaining the solid state battery is the same as that in Comparative Examples.

(Forming Process of the Solid State Battery Precursor (Unfired Laminating Body))

First, each of the positive electrode layer sheet 10A′, the solid electrolyte layer sheet 20′, and the negative electrode layer sheet 10B′, which were the components of the battery configuration unit, was prepared. In Examples, electrode layers 1 to 3 were used as the positive electrode layer sheet 10A′ and/or the negative electrode layer sheet 10B′ (see Table 2). Note that LAGP in Table 2 represents Li_{1.5}Al_{0.5}Ge_{1.5}(PO₄)₃. After the preparation of the respective sheets, the positive electrode layer sheet 10A′, the solid electrolyte layer sheet 20′, and the negative electrode layer sheet 10B′, which were the respective components of the battery configuration unit, were sequentially laminated along the laminating direction.

At this laminating stage, the terminal non-connection portion contact sheet (specifically, the insulating portion sheet) 30′ was provided in a side region of the electrode layer sheet 10′ by the screen printing. Specifically, the insulating portion sheet was provided so as to be in contact with the terminal non-connection portion 13′ excluding the portion 12′ to which the terminal was connected in the outer edge portion 11′ of the electrode layer sheet 10′. In Examples, insulating portion sheets 1 to 6 and 8 were used as the insulating portion sheets.

Next, thermocompression bonding at a predetermined pressure (75 MPa) and subsequent isostatic pressing at a predetermined pressure (200 MPa) were performed. As described above, the solid state battery precursor 500′ (unfired laminating body) was formed.

(Firing Process)

Next, the obtained solid state battery precursor 500′ (unfired laminating body) was subjected to firing. The firing was performed by heating at 750° C. in a nitrogen gas atmosphere. After firing, the terminal and the protective layer were provided on the obtained laminating body to such an extent that the terminal was not covered.

As described above, the solid state batteries according to an embodiment of the present invention were manufactured. Next, 10 battery base bodies obtained in each Example were prepared, each battery base body was embedded in a resin, and a polished section was observed. Finally, a non-defective rate was determined from the number of non-defectives among the 10 samples.

As a result, as illustrated in Table 2, in Examples 1 to 15 in which the ratio of the thermal expansion coefficient of the insulating portion containing the insulating material as a main component to the thermal expansion coefficient of the electrode layer 10 containing the electrode material (corresponding to the member configured of the active material, the conductive material, and the solid electrolyte material) as a main component was 0.7 or more and less than 1.5, which were the components of the obtained solid state batteries according to an embodiment of the present invention, it was found that the non-defective rate was 70% or more. Specifically, it was found that the non-defective rate was 70% or more when the ratio was 0.7 to 1.4. In addition, it was found that the non-defective rate was 80% or more when the ratio was 0.8 to 1.4. It was found that the non-defective rate was 90% or more when the ratio was 0.9 to 1.4. It was found that the non-defective rate was 100% when the ratio was 0.9 to 1.2.

| | | | Thermal | | | | Thermal | Ratio of | | Presence |
|---|---|---|---|---|---|---|---|---|---|---|
| | | | expansion | | | | expansion | thermal | Non- | or |
| Example | Electrode | | coefficients | Insulating | Main | Product | coefficient | expansion | defective | absence |
| No. | layer | Main ingredient | (×10−6/° C.) | layer | ingredient | name | (×10-6/° C.) | coefficient | rate (%) | of crack |
| 1 | Electrode | LiCoO₂ (40 wt %), | 12.9 | Insulating | BaO, | ASF-1702 | 11.9 | 1.1 | 100 | Absent |
| | layer 1 | Carbon (10 wt %), | | portion 1 | SiO₂, | | | | | |
| | | LAGP (50 wt %) | | | ZnO | | | | | |
| 2 | Electrode | LiCoO₂ (40 wt %), | 12.9 | Insulating | BaO, | ASF-1898 | 10.7 | 1.2 | 100 | Absent |
| | layer 1 | Carbon (10 wt %), | | portion 2 | B₂O₃, | | | | | |
| | | LAGP (50 wt %) | | | ZnO | | | | | |
| 3 | Electrode | LiCoO₂ (40 wt %) | 12.9 | Insulating | BaO, | ASF-1941B | 9.0 | 1.4 | 80 | Absent |
| | layer 1 | Carbon (10 wt %), | | portion 3 | SiO₂, | | | | | |
| | | LAGP (50 wt %) | | | B₂O₃, | | | | | |
| 4 | Electrode | Li₃V₂ (PO₄)₃ (30 wt %), | 9.6 | Insulating | BaO, | ASF-1702 | 11.9 | 0.8 | 80 | Absent |
| | layer 2 | TiO₂ (10 wt %), | | portion 1 | SiO₂, | | | | | |
| | | Carbon (10 wt %), | | | ZnO | | | | | |
| | | LAGP (50 wt %) | | | | | | | | |
| 5 | Electrode | Li₃V₂ (PO₄)₃ (30 wt %), | 9.6 | Insulating | BaO, | ASF-1898 | 10.7 | 0.9 | 100 | Absent |
| | layer 2 | TiO₂ (10 wt %), | | portion 2 | B₂O₃, | | | | | |
| | | Carbon (10 wt %), | | | ZnO | | | | | |
| | | LAGP (50 wt %) | | | | | | | | |
| 6 | Electrode | Li₃V₂ (PO₄)₃ (30 wt %), | 9.6 | Insulating | BaO, | ASF-1941B | 9.0 | 1.1 | 100 | Absent |
| | layer 2 | TiO₂ (10 wt %), | | portion 3 | SiO₂, | | | | | |
| | | Carbon (10 wt %), | | | B₂O₃ | | | | | |
| | | LAGP (50 wt %) | | | | | | | | |
| 7 | 7 Electrode | Li₃V₂ (PO₄)₃ (30 wt %), | 9.6 | Insulating | Bi₂O₃, | ASF-2511C | 8.2 | 1.2 | 100 | Absent |
| | layer 2 | TiO₂ (10 wt %), | | portion 4 | ZnO | | | | | |
| | | Carbon (10 wt %), | | | | | | | | |
| | | LAGP (50 wt %) | | | | | | | | |
| 8 | Electrode | Li₃V₂ (PO₄)₃ (30 wt %), | 9.6 | Insulating | Bi₂O₃, | ASF-1097 | 7.0 | 1.4 | 90 | Absent |
| | layer 2 | TiO2 (10 wt %), | | portion 5 | B₂O₃ | | | | | |
| | | Carbon (10 wt %), | | | | | | | | |
| | | LAGP (50 wt %) | | | | | | | | |
| 9 | Electrode | Li₃V₂ (PO₄)₃ (30 wt %), | 9.6 | Insulating | Al₂O₃, | ASF-1898 | 7.3 | 1.3 | 90 | |
| | layer 2 | TiO₂ (10 wt %), | | portion 8 | BaO, | 30 wt % Al₂0₃ | | | | |
| | | Carbon (10 wt %), | | | B₂O₃, | | | | | |
| | | LAGP (50 wt %) | | | ZnO | | | | | |
| 10 | Electrode | Li₃V₂ (PO₄)₃ (30 wt %), | 7.5 | Insulating | BaO, | ASF-1898 | 10.7 | 0.7 | 70 | |
| | layer 3 | SiO₂ (10 wt %), | | portion 2 | B₂O₃, | | | | | |
| | | Carbon (10 wt %) , | | | ZnO | | | | | |
| | | LAGP (50 wt %) | | | | | | | | |
| 11 | Electrode | Li₃V₂ (PO₄)₃ (30 wt %), | 7.5 | Insulating | BaO, | ASF-1941B | 9.0 | 0.8 | 70 | |
| | layer 3 | SiO₂ (10 wt %), | | portion 3 | SiO_{2,} | | | | | |
| | | Carbon (10 wt %), | | | B₂O₃, | | | | | |
| | | LAGP (50 wt %) | | | | | | | | |
| 12 | Electrode | Li₃V₂ (PO₄)₃ (30 wt %), | 7.5 | Insulating | Bi₂O₃, | ASF-2511C | 8.2 | 0.9 | 90 | |
| | layer 3 | SiO₂ (10 wt %), | | portion 4 | ZnO | | | | | |
| | | Carbon (10 wt %) , | | | | | | | | |
| | | LAGP (50 wt %) | | | | | | | | |
| | Electrode | Li₃V₂ (PO₄)₃ (30 wt %), | 7.5 | Insulating | Bi₂O₃, | ASF-1097 | 7.0 | 1.1 | 100 | |
| 13 | layer 3 | SiO₂ (10 wt %), | | portion 5 | B₂O₃ | | | | | |
| | | Carbon (10 wt %), | | | | | | | | |
| | | LAGP (50 wt %) | | | | | | | | |
| | Electrode | Li₃V₂ (PO₄)₃ (30 wt %), | 7.5 | Insulating | Bi₂O₃, | ASF-1098 | 5.4 | 1.4 | 80 | |
| 14 | layer 3 | SiO₂ (10 wt %), | | portion 6 | B₂O_{3,} | | | | | |
| | | Carbon (10 wt %) , | | | ZnO | | | | | |
| | | LAGP (50 wt %) | | | | | | | | |
| | Electrode | Li₃V₂ (PO₄)₃ (30 wt %), | 7.5 | Insulating | Al₂O₃ | ASF-1898+ | 7.3 | 1.0 | 100 | Absent |
| 15 | layer 3 | SiO₂ (10 wt %), | | portion 8 | Bao, | 30 wt % | | | | |
| | | Carbon (10 wt %) , | | | B₂O₃, | Al₂0₃ | | | | |
| | | LAGP (50 wt %) | | | ZnO | | | | | |

From the above, it was found that by limiting the ratio of the thermal expansion coefficient of the insulating portion to the thermal expansion coefficient of the electrode layer 10 to within the predetermined range of 0.7 or more and less than 1.5, the ratio of the non-defective rate becomes higher as compared with Comparative Examples. Note that in Examples, the insulating portion sheet was used, but the present invention is not limited thereto, and the solid electrolyte portion sheet can also be used.

Although an embodiment of the present invention has been described above, only typical examples of the application range of the present invention have been illustrated. Therefore, a person skilled in the art may easily understand that the present invention is not limited thereto and various modifications may be made.

The secondary battery according to an embodiment of the present invention can be used in various fields where electric storage is assumed. Although it is merely an example, the secondary battery according to an embodiment of the present invention, particularly the nonaqueous electrolyte secondary battery, can be used in the fields of electricity, information, and communication in which mobile devices and the like are used (mobile device fields such as, for example, mobile phones, smartphones, notebook computers, digital cameras, activity meters, arm computers, and electronic paper), home and small industrial applications (for example, the fields of electric tools, golf carts, and home, nursing, and industrial robots), large industrial applications (for example, the fields of forklifts, elevators, and harbor cranes), transportation system fields (for example, the fields of hybrid vehicles, electric vehicles, buses, trains, power-assisted bicycles, electric two-wheeled vehicles, and the like), power system applications (for example, fields such as various types of power generation, road conditioners, smart grids, and household installation type power storage systems), medical applications (medical equipment fields such as earphone hearing aids), medical applications (fields such as dose management systems), IoT fields, space and deep sea applications (fields such as, for example, space probes, submersible research vehicles, and the like), and the like.

### DESCRIPTION OF REFERENCE SYMBOLS

500: Solid state battery
500′, 500α′: Solid state battery precursor
300, 300α′: Exterior
300′: Exterior precursor
100: Battery configuration unit
30: Active material low-containing portion
30′, 30α′: Terminal non-connection portion contact sheet
30A: Positive electrode active material low-containing portion
30A′, 30Aα′: Terminal non-connection portion contact sheet
30B: Negative electrode active material low-containing portion
30B′, 30Bα′: Terminal non-connection portion contact sheet
20: Solid electrolyte layer
20′, 20α′: Solid electrolyte layer precursor
13, 13A, 13B, 13′: Outer edge portion (terminal non-connection portion)
12, 12A, 12B, 12′: Outer edge portion (terminal connection portion)
11: Outer edge portion of electrode layer
11A: Outer edge portion of positive electrode layer
11B: Outer edge portion of negative electrode layer
11′: Outer edge portion of electrode layer precursor
10: Electrode layer
10′, 10α′: Electrode layer precursor
10A: Positive electrode layer
10A′, 10Aα′: Positive electrode layer precursor
10B: Negative electrode layer
10B′, 10Bα′: Negative electrode layer precursor

1. A method of manufacturing a solid state battery, the method comprising:
forming a solid state battery precursor by sequentially laminating a positive electrode layer sheet, a solid electrolyte layer sheet, and a negative electrode layer sheet along a laminating direction;
providing a terminal non-connection portion contact sheet so as to contact a terminal non-connection portion of an outer edge portion of each of the positive electrode layer sheet and the negative electrode layer sheet, wherein the terminal non-connection portion contact sheet has a ratio of a thermal expansion coefficient of at least one of a solid electrolyte material and an insulating material contained in the terminal non-connection portion contact sheet to a thermal expansion coefficient of an electrode material contained in at least one of the positive electrode layer sheet and the negative electrode layer sheet of 0.7 or more and less than 1.5; and
firing the solid state battery precursor.

2. The method of manufacturing a solid state battery according to claim 1, wherein the ratio is 0.7 to 1.4.

3. The method of manufacturing a solid state battery according to claim 1, wherein the ratio is 0.8 to 1.4.

4. The method of manufacturing a solid state battery according to claim 1, wherein the ratio is 0.9 to 1.4.

5. The method of manufacturing a solid state battery according to claim 1, wherein the ratio is 0.9 to 1.2.

6. The method of manufacturing a solid state battery according to claim 1, wherein the insulating material contains a ceramic material and a glass material.

7. The method of manufacturing a solid state battery according to claim 1, wherein the terminal non-connection portion contact sheet is provided so as to surround the terminal non-connection portion of the outer edge portion of the electrode layer sheet in a plan view of the solid state battery precursor.

8. A solid state battery comprising:
at least one battery configuration unit including:
a positive electrode layer having a positive electrode material layer and a positive electrode layer active material low-containing portion contacting a terminal non-connection outer edge portion of the positive electrode material layer;
a negative electrode layer having a negative electrode material layer and a negative electrode layer active material low-containing portion contacting a terminal non-connection outer edge portion of the negative electrode material layer; and
a solid electrolyte layer interposed between the positive electrode layer and the negative electrode layer along a laminating direction,
wherein a ratio of a thermal expansion coefficient of at least one of (1) the positive electrode layer active material low-containing portion to a thermal expansion coefficient of the positive electrode material layer, and (2) the negative electrode layer active material low-containing portion to a thermal expansion coefficient of the negative electrode material layer, is 0.7 or more and less than 1.5.

9. The solid state battery according to claim 8, wherein the ratio is 0.7 to 1.4.

10. The solid state battery according to claim 8, wherein the ratio is 0.8 to 1.4.

11. The solid state battery according to claim 8, wherein the ratio is 0.9 to 1.4.

12. The solid state battery according to claim 8, wherein the ratio is 0.9 to 1.2.

13. The solid state battery according to claim 8, wherein the positive electrode layer active material low-containing portion and the negative electrode layer active material low-containing portion are at least one of a solid electrolyte portion and an insulating portion.

14. The solid state battery according to claim 13, wherein the insulating portion contains an insulating material, and the insulating material contains a ceramic material and a glass material.

15. The solid state battery according to claim 13, wherein
the positive electrode layer active material low-containing portion surrounds an entirety of the terminal non-connection outer edge portion of the positive electrode material layer in a plan view of the solid state battery, and
the positive electrode layer active material low-containing portion surrounds an entirety of the terminal non-connection outer edge portion of the negative electrode material layer in the plan view of the solid state battery.

16. The solid state battery according to claim 8, wherein
the positive electrode layer active material low-containing portion surrounds an entirety of the terminal non-connection outer edge portion of the positive electrode material layer in a plan view of the solid state battery, and
the positive electrode layer active material low-containing portion surrounds an entirety of the terminal non-connection outer edge portion of the negative electrode material layer in the plan view of the solid state battery.

17. The solid state battery according to claim 8, wherein the positive electrode layer and the negative electrode layer are layers capable of occluding and releasing lithium ions.
